(19) United States
(12) Patent Application Publication
(10) Pub. No.: US 2025/0002226 A1
(43) Pub. Date: Jan. 2, 2025

(54) DURABLE BOTTOM-DISPENSING CONTAINERS

(71) Applicant: The Procter & Gamble Company, Cincinnati, OH (US)

(72) Inventors: Vincent Hubert Monique DE WILDE, Holsbeek (BE); John William Rowe MACDONALD, Bath (GB); Stefan Max PALMBERG, Bristol (GB); Jonathan Edward Alexander STURGESS, Bath (GB); Eszter SZABO, Munich (DE); Pieter Paul Dirk Jenny Maria VAN DEN BERGH, Kobe (JP); Joost Marinus VERBURG, Antwerpen (BE); Man Shun YAU, Bath (GB)

(21) Appl. No.: 18/751,479

(22) Filed: Jun. 24, 2024

(30) Foreign Application Priority Data
Jun. 28, 2023 (EP) 23181979.8
Feb. 2, 2024 (EP) 24155433.6

(51) Int. Cl. B65D 35/46; B65D 35/08

(52) U.S. Cl. CPC B65D 35/46; B65D 35/08; B65D 2205/02

(57) ABSTRACT

A bottom dispensing package for a liquid composition includes a resiliently squeezable container for housing the liquid composition; and a base operably connected to the container, wherein the base comprises an orifice. The body of the base is at least partially made from an elastomer. The elastomer used in the base has a Shore A (Type A) hardness of from about 0 to about 80, and the shore A hardness is measured using the method described in ISO 868:2003.

### TECHNICAL FIELD

The present disclosure relates to durable bottom-dispensing containers.

### BACKGROUND

Liquid dispensers are widely used for various applications, including household products, personal care items, and industrial chemicals. Conventionally, liquid dispensers have been designed with top dispensing mechanisms, where the liquid is dispensed through an opening on the top of the container. A growing number of such products, and especially liquid detergent compositions, are provided in bottom-dispensing containers, also sometimes referred to as inverted containers, since they provide less hold-up of product inside the container, and enable easy dispensing.

In addition, there is a greater desire for consumer products to have a reduced environmental impact. However, a significant portion of the environmental impact is due to the packaging, even when the packaging is recyclable or made from recycled material. As such, there remains a desire to move away from single-use plastic products to more durable containers that can be reused repeatedly.

A particular challenge with these types of bottom-dispensing containers is the prevention of leakage of the liquid contained therein during steady state (i.e., storage) and/or upon impact, especially upon impact. For example, leakage may occur during storage when the inverted container is subjected to a temperature change, specifically increase (e.g., inverted container placed beside sunny window or near stove top, etc.), that can lead to internal pressure increases and leakage. Specifically, by “impact” it is meant that when the inverted container is handled, transported, dropped or knocked over. As a result of the impact, transient liquid pressure increases, also referred to as hydraulic hammer pressure, inside the container and can momentarily force open the valve causing liquid to leak out, which will result in consumer dissatisfaction with the product. Previous attempts to overcome the leakage problem have involved including a closing cap. However, inclusion of a closing cap means additional steps of having to open the closing cap for dosing and reclose the closing cap after the dosing process, which is undesirable to consumers.

Furthermore, the cap does not avoid liquid messiness and dried up crust of liquid around the spout/cap. Other attempts have incorporated baffles on top of the resilient valve (as described in JP2007/176594 and WO2000/68038), which have not completely resolved the leakage issue particularly as it pertains to inverted containers, more particularly upon impact. Impact resistance systems, such as described in EP3492400A1 have been highly effective at reducing or even eliminating leakage due to impact. However, the incorporation of such impact resistance systems adds complexity to the process of making the package. In addition, they can be difficult to clean, especially when residual liquid contained within the container has dried. As such, such impact resistance systems are less suited for durable containers which are cleaned and reused regularly.

As such, there remains a need for alternative means of reducing leakage due to impact, especially for durable and reusable bottom-dispensing containers.

EP3686118A1 relates to a bottom dispensing package comprising a base having an orifice comprising a slit-valve, which is less prone to leakage, even when a lower viscosity product is comprised in the container, is met by providing the container with a more elastic resiliently squeezable container. U.S. Pat. No. 5,213,236 relates to a dispensing package for fluid products such as liquid soaps, shampoos and conditioners, house hold detergents, cleaners, polishes, moisturizing creams, and the like, and includes a container with a self-sealing dispensing valve mounted therein. The valve includes a marginal flange, a valve head with a discharge orifice therein, and a connector sleeve having one end connected with the valve flange and the opposite end connected with the valve head adjacent a marginal edge thereof. The connector sleeve has a resiliently flexible construction, such that when pressure within the container raises above a predetermined amount, the valve head shifts outwardly in a manner which causes the connector sleeve to double over and extend rollingly. DE10122557A1 relates to a device on the removal hole which prevents the product dripping out after wall pressure by hands is released. The device contains slit segments in one plane and as many slit segments in a second plane, respective plane segments being positioned so the bottom edges of the first segments make contact with the top edges of the second segments in each case. Two or four segments are preferred and the container seal is by screw or snap action. Container lid and seal are hinged together and preferred segment thickness is 0.25 mm, the device diameter being 10-20 mm. CN2784322Y relates to a headstand bottle, which comprises a bottle body, a bottle cap and an outer packing cap, wherein the opening of bottle body is opened downwards; the bottle cap is fixedly connected to the lower end of the bottle body through a screw and is provided with a liquid outlet; a silica gel inner cap and an inner partition board are orderly fixed to the position between the opening of the bottle cap and the opening of the bottle body. Because the utility model has the opening opened downwards of the bottle body and adopts the silica gel inner cap and the partition board, liquid in the liquid bottle which is reversely arranged cannot flow out naturally. The utility model has the advantages of simple structure, convenient use and opening, sanitation and cleanness, application for bottles filled with little liquid, natural, convenient, and clean pouring of the liquid, and special application for loading various viscous liquid, such as liquid shampoo, cleanser essence, etc. CN1507827A relates to a wall liquid soap distributor for washroom. Said distributor adopts a bottle with a certain elasticity, said bottle can be inverted for use, its liquid outlet is smaller than mouth of general bottle, on the bottle mouth position a platform surface is formed, on the platform surface an elastic thin sheet is placed, and on the elastic thin sheet several opening and closing seams are set, a bottle cap whose inner wall has screw and whose centre has a circular hole can be tightly screw-turned on the bottle body and can be used for tightly pressing the opening and closing seams. The example is simple in structure, low in cost, and also provides its application method. US 2008/029548 A1 relates to dispensing packages for fabric treatment compositions, such as bottom dispensing packages for flowable compositions. US 2016/244222 A1 relates to a dispensing system that includes a bottle, a valve cap, a dosing cap, the bottle includes a side wall having at least a portion that is flexible, the valve cap regulates the dispensing of a flowable product from bottle into the dosing cap. EP3321199A relates to liquid condiment containers which include a bottle and a cap, and containing a condiment having a viscosity of from 5 Pa·s to 500 Pa·s, the bottle including a mouth, a body, and a bottom, the body having a flat shape in horizontal transverse section in an elected state, the bottle being made of low-density polyethylene as a main component, the bottle being flexibly deformed to easily discharge its content even when the content is a high-viscosity liquid condiment, and the original aesthetic appearance of the container is less liable to be impaired even when the content is reduced. EP3492400A relates to a liquid dispenser for dispensing liquid from an inverted container. The dispenser comprises a body, a valve and an impact resistance system especially adapted for absorbing transient liquid pressure increases (e.g., hydraulic hammer pressure) to substantially reduce/prevent undesirable opening of the valve and leakage of the liquid. EP3784578A relates to a structure of reinforcing ribs disposed circumferentially around a container body portion of a container, said structure of reinforcing ribs comprises: a pair of external ribs arranged around the bottle body, each external rib comprising a given pattern around the container body, said pattern being a series of at least two arcuate portions with a vertices interposed between two arcuate portions; the pair of external ribs having an upper external rib and a lower external rib, said external ribs having their vertices facing each other and shifted of a maximum distance of 5 mm and in which, the upper external rib has a maximum amplitude between 3 and 6.5 mm and an arcuate portion length of half of the container perimeter; and the lower external rib has a maximum amplitude between 2 and 5 mm and an arcuate portion length of half of the container perimeter. US20040000566A1 relates to a dispenser for liquids such as dish soaps, the dispenser includes a bottom-dispensing squeeze container with flow controlled by a pressure actuated, self-closing valve and a base integrated into the container, the container is ergonomically shaped to provide a handgrip to allow gripping with either hand from any direction and to provide a natural location to grip and squeeze the container, the base threads onto the stand to support the container on a surface while preventing other elements, such as the valve, to contact the surface and allow for a liquid to be dispensed through the stand.

### SUMMARY

The present disclosure relates to a bottom dispensing package (1) for a liquid composition comprising: a resiliently squeezable container (10) for housing the liquid composition; and a base (20) operably connected to said container (10), wherein the base comprises an orifice (30); wherein the body of the base (20) is at least partially made from an elastomer, wherein the elastomer used in the base (20) has a Shore A (Type A) hardness of from 0 to 80, wherein the shore A hardness is measured using the method described in ISO 868:2003.

### BRIEF DESCRIPTION OF THE DRAWINGS

FIG. 1 is a front view of a durable bottom-dispensing package (1) according to one embodiment of the present disclosure. The package (1) comprises a resiliently squeezable container (10) and a base (20). The resiliently squeezable container (10) comprises at least one container wall (11). The resiliently squeezable container (10) comprises a wider portion (3) and a narrower portion (2). The base (20) comprises a base wall rim (22) adapted for resting the package (1) on a flat surface in the upside-down position. The top of the container (10) comprises a one-way vent (70).

FIG. 2 is a cut away view of another embodiment of the present disclosure. The package (1) comprises a resiliently squeezable container (10) and a base (20). The resiliently squeezable container (10) comprises at least one container wall (11). The resiliently squeezable container (10) comprises a wider portion (3). The interior surface (15) of the container wall (11) comprises a zone (4) having grooves (80). The exterior wall (14) of the container wall (11) is smooth. The container (10) comprises an orifice (30) which comprises a slit-valve (40). The base (20) of the package (1) comprises a base wall (23) connected to the periphery of the bottom surface (21), and extending from said periphery of the bottom surface (21) to a base wall rim (22), such that the bottom-dispensing package (1) can rest on the base wall rim (22). The base wall (23) comprises a hole (26), connecting the exterior base wall surface (24) to the interior base wall surface (25).

FIG. 3 is a cut away view of another embodiment of the present disclosure. The package (1) comprises a resiliently squeezable container (10) and a base (20). The resiliently squeezable container (10) comprises at least one container wall (11). The container wall (11) has both a wider portion (2) and a narrow portion (3), with the narrow portion (3) being above the wider portion (2). The interior surface (15) of the container wall (11) comprises a zone (4) having grooves (80). The exterior wall (14) of the container wall (11) is smooth. The top of the container (10) comprises a one-way vent (70). The base (20) of the package (1) comprises a base wall (23) connected to the periphery of the bottom surface (21), and extending from said periphery of the bottom surface (21) to a base wall rim (22), such that the bottom-dispensing package (1) can rest on the base wall rim (22). The base (20) comprises an impact resistance system (50) localized upstream of the orifice (30). The impact resistance system (50) comprises a housing (51) having a cavity (52) therein and extending longitudinally and radially inwardly from the base (20), wherein the housing (51) comprises at least one inlet opening (53a) that provides a flow path for the liquid from the resiliently squeezable container (10) into the housing (51) and at least one outlet opening (53b) that provides a path of egress for the liquid from the housing (51) to the exterior atmosphere when the orifice (30) is opened. The cavity (52) is partially occupied by a compressible substance (54).

FIG. 4 is a cut away view of another embodiment of the present disclosure. The package (1) comprises a resiliently squeezable container (10) and a base (20). The resiliently squeezable container (10) comprises at least one container wall (11). The container wall (11) has both a wider portion (2) and a narrow portion (3), with the narrow portion (3) being above the wider portion (2). The interior surface (15) of the container wall (11) comprises a zone (4) having grooves (80). The exterior wall (14) of the container wall (11) is smooth. The top of the container (10) comprises a cap (90) which comprises a one-way vent (70). The base (20) of the package (1) comprises a base wall (23) connected to the periphery of the bottom surface (21), and extending from said periphery of the bottom surface (21) to a base wall rim (22), such that the bottom-dispensing package (1) can rest on the base wall rim (22). The base (20) comprises an impact resistance system (50) localized upstream of the orifice (30). The impact resistance system (50) comprises a housing (51) having a cavity (52) therein and extending longitudinally and radially inwardly from the base (20), wherein the housing (51) comprises at least one inlet opening (53a) that provides a flow path for the liquid from the resiliently squeezable container (10) into the housing (51) and at least one outlet opening (53b) that provides a path of egress for the liquid from the housing (51) to the exterior atmosphere when the orifice (30) is opened. The cavity (52) is partially occupied by a compressible substance (54). The base wall (23) comprises a four channels (27), which are equidistantly spaced and connect the exterior base wall surface (24) to the interior base wall surface (25).

FIG. 5 is a cut away view of part of the container wall (11) of the embodiment of FIG. 4, showing the grooves (80), and the groove top (82) and the groove bottom (83), as well as the exterior surface (14). FIG. 5 also shows the pitch (81) between adjacent grooves.

FIG. 6 is a cutaway view of a durable liquid-dispensing package. The package may have the same properties and features as detailed herein in relation to some or all of the previous figures, unless explicitly excluded or obviously incompatible. Similarly, some or all of the features described in relation to FIG. 6 may be implemented into the examples discussed in the previous figures.

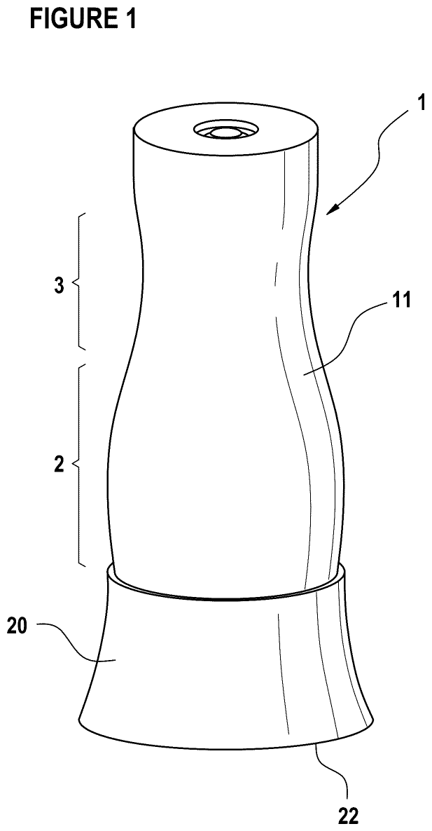

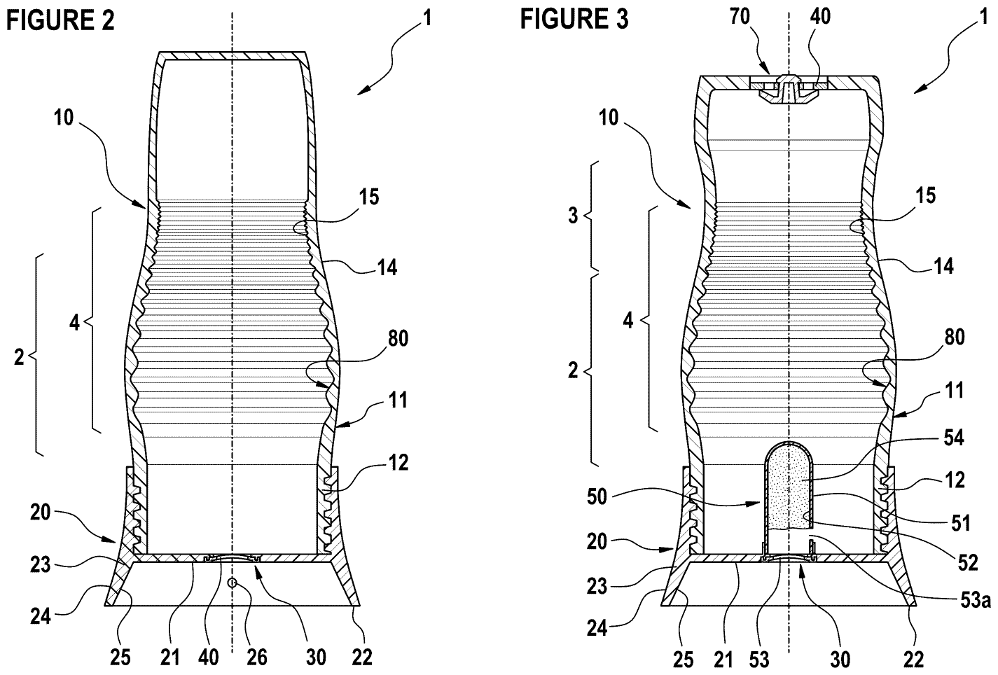

### DETAILED DESCRIPTION

It has been found that forming the base of the bottom-dispensing package, as described herein, wherein the base comprises an orifice, and wherein the body of the base is at least partially made from an elastomer, provides a means of reducing leakage due to impact, especially for durable and reusable bottom-dispensing containers.

By resiliently squeezable, what is meant is that the container wall (11) exhibits a degree of flexibility sufficient to permit deformation in response to manual forces applied to the outer surface of the container wall (11) and a degree of resilience sufficient to return automatically to its undeformed condition when said manually applied forces are removed from the outer surface of the container wall (11).

By the terms “a” and “an” when describing a particular element, we herein mean “at least one” of that particular element.

The term “dose” as used herein is defined as the measured amount of liquid to be delivered by the package. The dose begins when the liquid first exits the cap orifice (30) and ends once the flow of said liquid stops.

By “substantially independently from pressure” as used herein it is meant that pressure causes less than 10% variation from the target measured dose.

By “substantially constant liquid output or dosage” as used herein it is meant that variation from the target measured dose is less than 10%.

By “shear thinning” as used herein it is meant that the liquid referred to is non-Newtonian and preferably has a viscosity that changes with changes in shear rate.

By “drip-free” as used herein it is meant that no visible residue is left proximal to the nozzle of the cap following dosing and/or that no liquid exits the resilient container without squeezing.

A preferred field of use is that of dosage devices for domestic or household use, containing detergents such as hard surface cleaning compositions, liquid laundry detergent compositions, or other cleaning preparations, fabric conditioners and the like, typically having relatively low low-shear viscosities. A particularly preferred field of use is hard surface cleaning, especially manual dishwashing. For such applications, the resiliently squeezable container (10) can have an overflow volume, as measured using the method described herein, of from 0.1 litres to 5 litres, preferably from 0.2 litres to 1.5 litres, more preferably from 0.25 litres to 0.75 litres. The volume of liquid dosed for each squeeze of the package (1) is typically from 1 ml to 50 ml, preferably from 2 ml to 30 ml, more preferably 3 ml to 20 ml.

### Bottom-Dispensing Package:

The present disclosure is directed to a package (1) for repeatedly dosing a quantity of liquid. The package (1) comprises a resiliently squeezable container (10), and a base (20) operably connected to said container (10). The base comprises an orifice (30).

Bottom-dispensing packages (1) have several advantages over other packaging types. The package (1) does not need to be inverted, requiring fewer user motions for dispensing and providing greater positioning and dispensing control than for packages that dispense from orifices in the top of the package. In addition, there is no need to wait for the liquid contained within to reach the orifice before dispensing, especially when the amount of composition remaining within the package is low. Thus bottom-dispensing packages simplify activities such as hand dishwashing, where repeated dosing of detergent composition is required.

The bottom dispensing package (1) can be used as a dosage device for domestic or household use, containing detergents such as hard surface cleaning compositions, liquid laundry detergent compositions, or other cleaning preparations, fabric conditioners and the like. Other fields of use include dosage devices for manual and automatic dishwashing liquids, hair-care products and oral care applications such as mouth washes, beverages (such as syrups, shots of liquors, alcohols, liquid coffee concentrates and the like), food applications (such as food pastes and liquid food ingredients), pesticides, and the like. Preferably, the bottom dispensing container (1) comprises a hard surface cleaning composition, more preferably a hand dishwashing composition.

The bottom dispensing package (1) can have an internal volume, for the liquid contained therein, of from 0.1 litres to 5.0 litres, preferably from 0.2 litres to 1.5 litres, more preferably from 0.25 litres to 0.75 litres.

### Resiliently Squeezable Container:

The resiliently squeezable container (10) is preferably a bottle. The resiliently squeezable container (10) comprises at least one container wall (11).

The top of the container (10), distal from the base (20), can be closed. Alternatively, and preferably, the container can comprise a cap (90), the cap (90) preferably being detachable. Preferably the cap (90) is comprised on the top of the container, distal from the base (20). The cap (90) provides for easy refilling of the container (10) without the need to remove the base (20). The cap (90) can be a screw-on cap, or a push-fit cap or other form of cap which sealingly engages with the container (10). Since the container wall (11) is at least partially made from an elastomer, the container wall (11) is very flexible. As such, if needed, the cap (90) can comprise an attachment ring which is fixedly attached to the container wall (11), for instance via gluing or welding. Alternatively, the container wall (11) can be moulded on to the cap (90), or vice-versa. The cap (90) can be permanently attached to the enclosure, for instance, via a string or plastic chord, or maybe fully detachable. The cap (90), and if present its attachment ring is preferably rigid.

Historically, containers for bottom-dispensing applications were designed to be as stiff as possible, in order to maintain their form after use. When containers of the prior art are too elastic, the container does not readily return to its original form after being squeezed during use, or return to their original shape slowly. The latter case results in the user having to wait an unacceptable time before being able to dose a further quantity of composition.

Resin materials suitable for use in making the resiliently squeezable container (10) can be selected from the group consisting of: polyethylene terephthalate (PET), polypropylene (PP), low-density polyethylene (LDPE), high-density polyethylene (HDPE) and mixtures thereof, preferably polyethylene terephthalate (PET), or high-density polyethylene (HDPE), more preferably polyethylene terephthalate (PET). Such materials are particularly suitable when forming the container (10) using an injection stretch blow-moulding process.

The resiliently squeezable container (10) formed from such resins can be made using any suitable process, though blow-moulding (BM) processes, and especially injection stretch blow-moulding (ISBM) processes are preferred.

In extrusion blow-moulding, the molten resin is extruded (typically continuously) to form an open-ended continuous tube (a “parison”). The extruded resin is cut at regular intervals and the cuts are directly blow-moulded to form an article. In the extrusion blow-moulding process, the molten resin material is typically not first formed into a preform. The final shape of an article produced by extrusion blow-moulding is less precise and less controllable than those obtained by injection blow-moulding. Further details on extrusion blow-moulding can be obtained in general packaging textbook, for example in “The Wiley Encyclopaedia of Packaging Technology”, referred to above (in particular pages 83-86). Extrusion blow-moulding may be used to obtain laminated or co-extruded containers with multiple layers for aesthetic or improved physical (barrier) properties.

Injection blow-moulding (IBM) and its variant, injection stretch blow-moulding (ISBM), are commonly used to manufacture high quality hollow articles, such as containers, on an industrial scale. Preferably, the resiliently squeezable container (10) is made by blow-moulding a preform, for instance, using an injection-stretch blow-moulding process.

In the first step of both IBM and ISBM processes, a preform is made, typically by an injection-moulding process, as described earlier. Such preforms are typically test-tube shaped, having a fully formed neck (12) by which the preform is handled during processing. The wall thickness of the preform can be varied in order to affect the distribution of resin material in the resiliently squeezable container (10).

The neck (12) typically comprises an attachment means for attaching the base (20), such as a screw thread or bayonet mount, as is known in the art, with the base (20) comprising the corresponding part of the attachment means.

The preform is subsequently blow-moulded or stretch blow-moulded to form the resiliently squeezable container (10). As mentioned earlier, the neck of the preform typically remains substantially unchanged during the blow-moulding process while the body of the preform will expand considerably. The preform can be blow moulded, or stretch blow moulded, immediately after forming. Alternatively, the preform can be stored, or transported to a different location, before later being reheated and blown into the final container.

In the injection “blow-moulding process”, the preform is reheated, if necessary, before being transferred to a blow-mould having the shape of the desired hollow container. The preform is held by the neck (12) and air passing through a valve inflates the hot preform, which is typically at a temperature of from 85° C. to 115° C. The preform expands and takes the form of the blow-mould. Typically, little or no axial stretching takes place. After the desired container has sufficiently cooled to be handled, it is removed from the blow-mould and is ready for use. More information on injection blow-moulding processes can be obtained from general textbooks, for example “The Wiley Encyclopaedia of Packaging Technology”, Second Edition (1997), published by Wiley-Interscience Publication (in particular see page 87).

In the injection “stretch blow moulding” process (sometimes referred to as biaxial-orientation blow-moulding), the preform is reheated to a temperature warm enough to allow the preform to be inflated so that a biaxial molecular alignment in the sidewall of the resulting blow-moulded container is achieved. With the preform held at the neck (12), air pressure, and usually a stretch rod, are used to stretch the preform in the axial direction, and optionally also in the radial direction. Unlike containers obtained by conventional injection blow-moulding, the containers obtained by injection stretch blow-moulding are significantly longer than the preform (1). More information on injection stretch blow-moulding processes can be obtained from general textbooks, for example “The Wiley Encyclopaedia of Packaging Technology”, Second Edition (1997), published by Wiley-Interscience Publication (in particular see pages 87-89).

The desired elasticity of the resiliently squeezable container (10) can be achieved using any suitable means, including through the selection of the resin material used for forming the container (10), limiting the wall thickness through using less resin material to make the container (10), and by including at least one flexible panel (13) in the resiliently squeezable container (10), or by having a non-circular cross-section, or a combination thereof.

Since a relatively high container elasticity is desired, the resiliently squeezable container (10) can comprise the resin material, such that the ratio of weight of the resin material (in grams) to the overflow volume (in millilitres) is less than 0.058:1, preferably from 0.035:1 to 0.057:1, more preferably from 0.040:1 to 0.054:1. The higher elasticity also results in a container (10) which is more flexible, durable, and less prone to cracking due to repeated squeezing.

The present package (1) can be foreseen to be durable so that it can be repeatedly refilled and re-used. In contrast, prior art containers, made using materials such as polyethylene terephthalate (PET), polyethylene, polypropylene, and the like, are prone to strain-hardening and cracking after repeated use, especially when at the thickness to provide the desired spring-back after use.

Therefore, the container wall (11) of use in the present disclosure is preferably at least partially made from an elastomer, preferably wherein the elastomer is selected from the group consisting of: thermoplastic elastomer, silicone rubber, rubber, or a combination thereof, with thermoplastic elastomers and/or silicone rubber being preferred and thermoplastic elastomers being particularly preferred. The container wall (11) is preferably fully made from the elastomer, with the exception of any components that are necessary for connecting the optional cap (90) and/or base (20).

Elastomers are polymers with viscoelasticity, generally having low Young's modulus and high yield strain compared with other materials. Elastomers are amorphous polymers existing above their glass transition temperature, so that considerable segmental motion is possible. As such, they are relatively soft and deformable at ambient temperatures, for instance 21° C.

Thermoplastic elastomers (TPE) are copolymers or a physical mix of polymers, such as a plastic and a rubber, which comprises materials with both thermoplastic and elastomeric properties. Thermoplastic elastomers are relatively easy to manufacture, for example, by injection molding. Thermoplastic elastomers show advantages typical of both rubbery materials and plastic materials. The principal difference between thermoset elastomers and thermoplastic elastomers is the type of crosslinking bond in their structures. The crosslink in thermoset polymers is a covalent bond, such as created during a vulcanization process. In contrast, the crosslink in thermoplastic elastomer polymers is physical, reversible, typically comprising entanglements, a weaker dipole or hydrogen bond or a difference in material phase such as crystalline regions. For example, one of the constituent polymers, or segments of the constituent polymer has a melting or glass transition temperature well above room temperature. Examples of suitable thermoplastic elastomers, methods of making them, and methods of processing that, can be found in “Handbook of Thermoplastic Elastomers”, December 2007, Drobny, ISBN 9780815515494.

Thermoplastic elastomers include reactor-made thermoplastic elastomers, such as styrene block copolymers (SBC), thermoplastic polyether block amides (TPA), thermoplastic polyurethane elastomer (TPU) and thermoplastic copolyester elastomer (TCA). Reactor-made thermoplastic elastomers are implemented in one polymer that is formed through a reaction process which results in polymer segments that provide the thermoplastic properties and polymer segments that provide the elastomeric properties. Other thermoplastic elastomers comprise a blend of polymers, such as homopolymers and/or copolymers, that give rise to crystalline domains where blocks from the polymer co-crystallizes with blocks in adjacent chains, such as in copolyester rubbers. Depending on the block length, the domains are generally more stable than the latter owing to the higher crystal melting point. That crystal melting point determines the processing temperatures needed to shape the material, as well as the ultimate service use temperatures of the resultant thermoplastic elastomer. Such materials include Hytrel®, a polyester-polyether copolymer and Pebax®, a nylon or polyamide-polyether copolymer. Reactor-made thermoplastic elastomers are preferred, especially thermoplastic polyurethane elastomers (TPUs).

Thermoplastic elastomers, often referred to as “thermoplastic olefins” are typically derived from polyolefins and are also preferred due to their improved recyclability. The thermoplastic elastomer can contain further ingredients such as plasticizers, fillers, compatibilizers, and the like.

Silicone rubbers are elastomers composed of silicone. Silicone rubbers are often one- or two-component polymers, and may comprise fillers to improve properties or reduce cost. Silicone rubber is generally non-reactive, stable, and resistant to extreme environments and a wide range of temperatures, while still maintaining their properties. Due to these properties and ease of manufacturing and shaping, silicone rubber can be found in a wide variety of products, including voltage line insulators; automotive applications; cooking, baking, and food storage products; apparel such as undergarments, sportswear, and footwear; electronics; medical devices and implants; and in home repair and hardware, in products such as silicone sealants. Silicone is typically a highly adhesive gel or liquid, which is converted to silicone rubber by curing, such as through vulcanisation (condensation curing), catalysed curing, or peroxide curing. This is normally carried out in a two-stage process at the point of manufacture into the desired shape, and then in a prolonged post-cure process. The curing process can be accelerated by adding heat or pressure.

Suitable rubbers can be either naturally derived, or synthetically derived. Naturally derived rubber comprises suitable polymers derived from natural sources, most often isoprene with minor impurities of other organic compounds. Natural rubber is typically harvested in the form of latex. The latex is then refined into rubber ready for commercial processing. Synthetically derived rubber is an artificial elastomer, derived from petroleum byproducts, which is crosslinked via vulcanisation. Rubber can be used either alone or in combination with other materials.

The elastomer has a Shore A (Type A) hardness of from 0 to 80, preferably 5 to 60, more preferably 10 to 40. The Shore A hardness can be measured using the method described in ISO 868:2003 (last reviewed and confirmed in 2018). The elastomer can have a tensile elongation (break), measured in the flow direction at a stretch rate of 200 mm/min at 23° C. using the method described in ISO 37:2017 (last reviewed and confirmed in 2022), of from 200% to 1000%, preferably from 250% to 750%, more preferably from 300% to 700%. The elongation at break is a characteristic value that describes the maximum percentage elongation that a tensile specimen experiences at the moment of break. It therefore describes the deformability of a material under tensile load. The elastomer can have a compression set, measured at 23° C. over 72 hours using the method described in ISO 815-1:2019, of less than 50%, preferably less than 35%, more preferably less than 20%. The compression set measures the ability of the elastomer to withstand hardening and retain their elastic properties at ambient temperatures after prolonged compression. As such, the compression set provides an indication of the ability of the elastomer to withstand physical or chemical changes which prevent the elastomer from returning to its original dimensions after release of the deforming force, or lose too much of its elasticity.

The container wall (11) can have a wider portion (3), such that at least part of the exterior surface of the container (10) has a convex shape. The wider portion (2) is preferably situated on the container wall (11) where the container (10) would typically be gripped and squeezed. For good gripping and dispensing, the wider portion (2) preferably has a radius of from 25 mm to 120 mm, preferably from 40 mm to 100 mm, more preferably from 50 mm to 80 mm. Where the cross-section of the wider portion (2) of the container wall (11) is non-circular, such as oval, the radius is calculated based on a circular cross-section having the same cross-sectional area. The radius of the wider portion (2) is calculated where the cross-sectional area is a maximum.

The container wall (11) can have a narrow portion (3), such that at least part of the exterior surface of the container wall (11) has a concave shape which is narrower that the adjacent parts of the container (10).

The narrow portion (3) is preferably situated adjacent to the wider portion (2) of the container wall (11), and in particular, adjacent to where the container wall (11) would typically be gripped and squeezed. The narrow portion (3) preferably has a radius of from 10 mm to 80 mm, preferably from 20 mm to 70 mm, more preferably from 30 mm to 60 mm. Where the cross-section of the narrow portion (3) of the container wall (11) is non-circular, such as oval, the radius is calculated based on a circular cross-section having the same cross-sectional area. The radius of the narrow portion (3) is calculated where the cross-sectional area is a minimum.

The at least one groove (80) is preferably at least partially positioned in the wider portion (2) of the container wall (11).

The container wall (11) preferably has both a wider portion (2) and a narrow portion (3), more preferably wherein the narrow portion (3) is above the wider portion (2). Such containers (10) provide improved spring-back to the original shape once the squeezing pressure has been removed.

The wider portion (2) and preferably both the wider portion (2) and the narrow portion (3) have either a circular or oval cross section, with a circular cross section being preferred. It has been found that such cross-sections result in improved spring-back of the container wall (11) back to the original shape, after the squeezing pressure has been removed. This is in contrast to stiffer bottom-dispensing containers such as those made from polyethylene terephthalate (PET), polyethylene, polypropylene, and the like, where an essentially flat front panel and preferably also a back panel are more desired.

That container (10) can have a height of from 75 mm to 300 mm, preferably from 100 ml to 270 ml, more preferably from 150 mm to 225 mm, wherein the height of the container is measured from the inner-surface of the orifice (30) which is within the bottom-dispensing package (1), to the top of the container (10) or, if present, the top of the cap (90).

The container wall (11) can have a thickness of from 0.25 mm to 8.0 mm, preferably from 0.5 mm to 6.0 mm, more preferably from 1.0 to 4.0 mm. Where the grooves (80) are present, the wall thickness is measured as the distance between the exterior surface (14) and the groove top (82), measured perpendicular to the exterior surface (14) of the container wall (11).

The resiliently squeezable container (10) can be made using any suitable moulding process, such as injection moulding, rotational moulding or compression moulding.

Injection moulding is a method to obtain moulded products by injecting plastic materials molten by heat into a mould, and then cooling and solidifying them. The method is suitable for the mass production of products with complicated shapes. With injection moulding, the elastomer is first melted down so that it can be put into the injection unit. The injection unit can be a plunger, an extruder or similar. The injection unit is typically heated to above the melt temperature of the elastomer. The melted elastomer is then injected into the mould. Once injected, it can be vulcanized or cooled so that it forms the shape of the mold, creating an elastomer molded part. For thermoplastic elastomers, cooling is typically sufficient, With transfer moulding, the elastomer is heated and not the mould. The liquid elastomer remains in a melted state until the moulding process begins. An injector, such as a plunger, pushes the elastomer into the closed mould where it forms the shape after being cooled or vulcanized.

Once cooled, the mould can be opened to release the container, Compression moulding is a method of moulding in which the moulding material, generally preheated, is first placed in an open, heated mould cavity. The mould is closed with a top force or plug member, pressure is applied to force the material into contact with all mould surfaces, while heat and pressure are maintained until the moulding material has cured. Where the process employs thermosetting resins, for instance in a partially cured stage, either in the form of granules, putty-like masses, or preforms, the process is essentially a vulcanisation process. For improved strength or resiliency, fibres can be added to the moulding material. Advanced composite thermoplastics can also be compression molded with unidirectional tapes, woven fabrics, randomly oriented fiber mat or chopped strand. The elastomer may be loaded into the mould either in the form of pellets or sheet, or the mould may be loaded from a plasticating extruder. Materials are heated above their melting points, formed and cooled. The more evenly the feed material is distributed over the mold surface, the less flow orientation occurs during the compression stage. Compression moulding can also be used to produce sandwich structures that incorporate a core material such as a honeycomb or polymer foam into the resiliently squeezable container (10).

### At Least One Groove:

The interior surface (15) of the resiliently squeezable container (10) can comprise at least one circumferentially oriented groove (80), especially when the container (10) is at least partially made of a durable material such as elastomer, more preferably when the container wall (11) is made from such materials. Providing the at least one circumferentially oriented groove (80) on the interior surface results in greater flexibility and springback of the container while ensuring that the exterior surface (14) can be left smooth or textured as desired, for example, by the addition of a logo or trademark. In addition, the exterior surface (14) of the container (10) remains easy to clean. The at least one groove (80) is preferably essentially horizontally oriented. As such, the groove (80) can have a spiral form or can be one or more horizontal groove (80). Multiple horizontal grooves (80) are preferred.

The presence of such grooves has been found to improve reinflation of the resiliently squeezable container (10) back to its original shape, even when the container is made from a flexible material such as an elastomer, and especially when the at least one groove (80) is positioned where the container (10) has a wider portion (2), such that at least part of the exterior surface of the container (10) has a convex shape, and particularly when the wider portion (2) is situated on the container (10) where the container (10) would typically be gripped and squeezed.

The at least one circumferentially oriented groove (80) can extend over at least 70%, preferably at least 80%, more preferably at least 95%, most preferably 100% of the circumferential length of the interior surface (15) of the container wall (11) where the at least one circumferentially oriented groove (80) is positioned.

The interior surface (15) of the container wall (11) preferably comprises multiple circumferentially oriented grooves (80). The circumferentially oriented grooves (80) can be present over a groove zone (4) which extends over at least 25%, preferably at least 50%, more preferably at least 75% of the height of the container wall (11).

Where the circumferentially oriented grooves (80) are present, the grooves (80) can be spaced out such that the pitch (81) is from less than 1 mm to 15 mm, preferably from 2 mm to 12 mm, more preferably from 2.5 mm to 10 mm, wherein the pitch (81) is defined as the distance between two adjacent peaks of the circumferentially oriented grooves (80) on the interior surface (15) of the resiliently squeezable container.

The pitch (81) can be constant, but more preferably varies across the interior surface (15) of the container wall (11). The pitch (81) can increase as the grooves (80) progress up the interior surface (15) of the container wall (11) and then decrease again, so that the pitch (81) is widest where the container wall (11) would typically be gripped and squeezed. Such a distribution of the pitch (81) results in increased flexibility of the container wall (11) where the container (10) is gripped and squeezed, and increased rigidity for the container wall (11) further away from this position, and hence improved spring-back of the container (10) without increasing its stiffness.

As mentioned earlier, where the grooves (80) are present, the container wall (11) can have a thickness of from 0.25 mm to 8.0 mm, preferably from 0.5 mm to 6.0 mm, more preferably from 1.0 to 4.0 mm, measured as the distance between the exterior surface (14) and the groove top (82), measured perpendicular to the exterior surface (14) of the container wall (11).

The distance between the groove bottom (83) and the exterior surface (14) of the container wall (11) can be from 0.1 mm to 6.0 mm, preferably from 0.5 mm to 5.0 mm, most preferably from 1.0 mm to 3.0 mm.

The height of the at least one circumferentially oriented groove (80) can be from 0.1 mm to 6.0 mm, preferably from 0.5 mm to 5.0 mm, preferably from 1.0 mm to 3.0 mm, wherein the height is measured as the distance between the groove bottom (83) and the groove top (82), both measured perpendicular to the exterior surface (14) of the container wall (11).

Where the grooves (80) are not present, the container wall (11) can have a thickness of from 0.25 mm to 8.0 mm, preferably from 0.5 mm to 6.0 mm, more preferably from 1.0 to 4.0 mm, measured perpendicular to the exterior surface (14) of the container wall (11). As such, the container wall (11) where the grooves (80) are not present can be thicker or thinner than the thickness of the wall (11) where the grooves (80) are present. In preferred embodiments, the wall (11) where the grooves (80) are not present is thicker than the thickness of the wall (11) where the grooves are present. In such embodiments, the container wall (11) flexibility is highest where the grooves (80) are present.

The above features all result in both easy squeezing and improved spring back after the squeezing pressure is removed.

The exterior surface (14) of the container wall (11) can comprise further grooves or ribs. However, the exterior surface is preferably essentially free of such further grooves or ribs, with the possible exception of such further grooves and ribs which form part of a mark, such as a trademark, ingredients, or the like. Where such further grooves or ribs are present on the exterior surface (14) of the container wall (11), the thickness of the container wall (11) and the distance between the groove bottom (83) and the exterior surface (14) of the container wall (11) are measured assuming such further grooves, ribs and other markings are not present on the exterior surface (14) of the container wall (11). That is, assuming that the exterior surface (14) is smooth.

### One-Way Vent:

The resiliently squeezable container (10) can comprise a one-way vent (70). The one-way vent (70) allows the ingress of air into the container (10) while preventing the egress of air or other contents from the container (10). The one-way vent (70) is preferably positioned on the top of the container (10), and/or in the container wall (11) above a height of 90% of the height of the package, with the top of the container (10) being preferred. Where the container (10) comprises a cap (90), the one-way vent (70) is preferably positioned in the cap (90), and is more preferably centred in the cap (90).

Caps comprising a one-way vent are commercially available, such as the vented caps sold by Dow Corning and Nalgene. However, such caps are typically designed for venting gases from within the container to the outside to prevent pressure build up within the container, while preventing ingress of air into the container. In contrast, a suitable cap (90) comprising a one-way vent (70), for use in the present disclosure, must allow air to enter the container through the one-way vent (70), while preventing egress of the contents of the container (10) through the one-way vent (70).

For typical bottom-dispensing packages (1), the spring-back of the container (10) after the squeezing force for dispensing has been removed provides the pressure differential to draw air through the orifice (30), so that the container (10) can return to its original shape after squeezing of the container (10). As such, with typical prior art resiliently squeezable containers, the container has to be sufficiently stiff that it is able to provide sufficient spring-back force to draw air through the orifice (30) and allow the container (10) to return to its original shape. When the resiliently squeezable container (10) comprises the one-way vent (70) as described herein, the container (10) can be made more malleable, while still being able to return back to its original shape after the squeezing force for dispensing has been removed.

As such, when the container (10) comprises a one-way vent (70), the resiliently squeezable container (10) can have an elasticity index of from 0.75% to 1.75%, preferably from 0.85% to 1.4%, as measured using the elasticity index method described herein.

The desired elasticity of the resiliently squeezable container (10) can be achieved using any suitable means, including through the selection of the material used for forming the container (10), limiting the wall thickness through using less resin material to make the container (10), or through the use of grooves (80) as described herein, and their form.

As mentioned earlier, the one-way vent (70) allows the container (10) to recover to its original shape, while not requiring air to be suctioned through the orifice (30). As such, the orifice (30) can be made more resilient against leakage of the composition contained within the package (1). The one-way vent (70) preferably has an opening pressure which is less than the pressure required to draw air back though the orifice (30) of the base (20).

The one-way vent (70) can have an opening pressure differential from the exterior side (45) to the interior side (46) of from 10 mbar to 250 mbar, preferably from 15 mbar to 150 mbar, more preferably from 25 mbar to 75 mbar, measured at 20° C.

The opening pressure differential (in mbar) is typically measured using a water column, to which the valve has been sealingly attached to the bottom of the water-column, then measuring the water-height required to open the valve, at the target temperature. The opening pressure is typically available from the valve manufacture, including on technical literature provided for the valve.

Suitable one-way valves include: duckbill valves, umbrella valves, flapper valves, ball valves, degassing valves, and spring-loaded valves.

Duckbill valves are typically one-piece, elastomeric components that act as backflow prevention devices or one-way valves or check valves. They have elastomeric lips in the shape of a duckbill which prevent backflow and allow forward flow. The main advantage of duckbill valves over other types of one-way valves is that duckbill valves are self-contained, in that the critical sealing function is an integral part of the one-piece elastomeric component as opposed to valves where a sealing element has to engage with a smooth seat surface to form a seal. Therefore, duckbill valves are easily incorporated and assembled into a wide variety of devices without the hassle or problems associated with the surface finish quality of mating seats and/or complex assembly processes. Duckbill valves can be supplied by Minivalve (Netherlands).

Umbrella valves and Belleville valves are elastomeric valve components that have a diaphragm shaped sealing disk (umbrella shape). These elastomeric components are used as sealing elements in backflow prevention devices or one-way valves or check valves, in vent valves or pressure relief valves and in metering valves. When mounted in a seat, the convex diaphragm flattens out against the valve seat and absorbs a certain amount of seat irregularities and creates a certain sealing force. The umbrella valve will allow forward flow once the head pressure creates enough force to lift the convex diaphragm from the seat and so it will allow flow at a predetermined pressure in one way and prevent back flow immediately in the opposite way. Umbrella valves can be supplied by Minivalve (Netherlands).

Degassing valves can typically be found on bags of coffee and allow gases that are generated by the roasted beans to escape from the bag. When used in the present disclosure, the degassing valve is inversely mounted so that air can pass into the package (1) through the one-way vent (70) but not pass out of the package. Degassing valves are well known and typically comprise a cap, an elastic disc, a viscous layer, a plate usually made from polyethylene, and a paper filter. The elastic disc, such as a rubber diaphragm, is enclosed in the valve, and the side positioned on the exterior side of the container (10) or cap (70) has a viscous layer of sealant liquid that maintains surface tension against the valve. Once the pressure differential from the resiliently squeezable container (10) elastically returning to its original shape exceeds the surface tension, the elastic disc is released and air is able to ingress into the container (10). Suitable degassing valves are provided by EPAC Flexibles (Ghana), MTPak (China), WIPF Doypak (Turkey), and the like. Since the degassing valve is inversely mounted to the container (10) or cap (70), the valve is preferably protected by an air-permeable cover.

Spring loaded valves comprise a spring which holds a closure means such as a ball or pin in place. As such, an opposing pressure differential is required to open the valve. The spring can be metal or another elastic material such as a suitable plastic or rubber.

### Base:

The package comprises a base (20) operably connected to the container (10). The base comprises an orifice (30) which optionally comprises a slit-valve (40).

The base (20) can comprise a cap, not shown) which is at least partially detachable, more preferably fully removable from the base (20). When the package is more resistant to leakage due to changes in pressure during use, transport and storage, the cap is preferably not sealingly engaged to the orifice (30). Preferably, the base (20) does not comprise a cap or the base (20) comprises a cap which is fully detachable and can be removed and discarded prior to first use. Alternatively, the base (20) can also comprise a sticker covering the orifice (30) as additional protection against leakage during transport.

A suitable slit-valve (40) can be a flexible, elastomeric, resilient, bi-directional, self-closing, slit-type valve mounted within the orifice (30). The slit-valve (40) comprises a flexible central portion (41) having a slit or slits (42) therein. The slits (42) typically extend radially outward towards distal ends (43). For example, the orifice (30) may comprise a slit-valve (40) formed from one slit (42) or two or more intersecting slits (42), that may open to permit dispensing of liquid through the orifice (30) in response to an increased pressure inside the resiliently squeezable container (10), such as when the resiliently squeezable container (10) is squeezed. The slit-valve (40) preferably comprises at least two coincident slits (42), preferably wherein the slits form a star pattern, defining flaps (44). More preferably, the slit-valve comprises two coincidental slits (42) to balance ease of dosing and prevention of leakage.

The slit-valve (40) is typically designed to close the orifice (30) and stop the flow of liquid through the orifice (30) upon a reduction of the pressure differential across the slit-valve (40). The amount of pressure needed to open the slit-valve (40) will partially depend on the internal resistance force of the slit-valve (40). The “internal resistance force” (i.e., cracking-pressure) refers to a pre-determined resistance threshold to deformation/opening of the slit-valve (40). In other words, the slit-valve (40) will tend to resist deformation/opening so that it remains closed under pressure of the steady state liquid bearing against the interior side (45) of the orifice (30).

The amount of pressure needed to deform/open the valve must overcome this internal resistance force. This internal resistance force should not be so low as to cause liquid leakage. Accordingly, the slit-valve (40) preferably has an opening pressure differential from the interior side (45) to the exterior side (46) of the orifice (30) of at least 10 mbar, preferably at least 15 mbar, more preferably at least 25 mbar, measured at 20° C. The internal resistance force should not be so high as to make dispensing a dose of liquid difficult.

Especially where the bottom-dispensing package (1) comprises a low viscosity liquid, the use of a slit valve (40) which opens at a relatively low-pressure differential helps to avoid spurting of the composition out of the orifice (30). As such, especially where the bottom dispensing package (1) comprises a liquid detergent composition having viscosity of from 100 mPa·s to 3,000 mPa·s, preferably from 300 mPa·s to 2,000 mPa·s, most preferably from 500 mPa·s to 1,500 mPa·s, measured at a shear rate of 10 s⁻¹, the slit valve (40) preferably opens at a pressure differential of from 10 to 250 mbar, preferably from 15 to 150 mbar, more preferably from 25 to 75 mbar, measured at 20° C.

Moreover, the use of a slit-valve (40) which opens at such low-pressure differentials also means that a smaller pressure differential is required to draw air through the slit-valve (40) once the squeezing has been removed, so that the container (10) can return to its original shape. This is particularly important for packages (1) which comprise a more elastic container (10) since an insufficient pressure differential across the slit-valve (40) means that not enough air is drawn through the valve (40) and into the container (10) for the container to revert back to its undeformed shape.

The opening pressure differential (in mbar) is typically measured using a water column, to which the slit-valve has been sealingly attached to the bottom of the water-column, then measuring the water-height required to open the slit valve, at the target temperature. The opening pressure is typically available from the valve manufacture, including on technical literature provided for the valve.

Preferably the slit-valve (40) has a surface area of between 0.1 cm² and 10 cm², more preferably between 0.3 cm² and 5 cm², most preferably between 0.5 cm² and 2 cm². Preferably the slit-valve (40) has a height of between 1 mm and 10 mm, more preferably between 2 mm and 5 mm. Other dimensions could be used so long as they allow for the slit-valve (40) to remain in the fully closed position at rest.

The slit-valve (40) can be made from a thermoplastic elastomer, silicone, and mixtures thereof, preferably from silicone, and may comprise additives known in the art, such as for optimizing the valve durability and flexibility.

Since the resiliently squeezable container is made from an elastomer, the bottom dispensing package (1) of the present disclosure is less prone to leakage due to pressure changes during storage and transport, for instance, from variations in temperature. However, leakage can also be due to transient liquid pressure increases from impact, such as if the package is dropped or placed on a surface with sufficient force. Such transient liquid pressure increases, also referred to as hydraulic hammer pressure, inside the container can momentarily force open the valve causing liquid to leak out.

As such, the base (20) of the bottom dispensing package (1) can further comprise: an impact resistance system (50) localized upstream of the orifice (30), as described in EP3492400A1. The system (50) comprises a housing (51) having a cavity (52) therein and extending longitudinally and radially inwardly from the base (20), wherein the housing (51) comprises at least one inlet opening (53a) that provides a flow path for the liquid from the resiliently squeezable container (10) into the housing (51) and at least one outlet opening (53b) that provides a path of egress for the liquid from the housing (51) to the exterior atmosphere when the orifice (30) is opened, wherein the cavity (52) is adapted to be partially occupied by a compressible substance (54).

A suitable compressible substance (54) can be selected from a gas, a foam, a sponge or a balloon, preferably a gas, more preferably air. The ratio of the volume of the gas, preferably air, inside the housing (51) at a steady-state to the volume of the resiliently squeezable container (10) can be higher than 0.001, preferably between 0.005 and 0.05, more preferably between 0.01 and 0.02.

The housing (51) can have an internal volume of from 200 mm3 to 250,000 mm3, preferably from 1,500 mm3 to 75,000 mm3. The inlet opening (53a) can have a total surface area of 1 mm2 to 250 mm2, preferably 15 mm2 to 150 mm2. The housing (51) typically comprises, or is made from, a plastic material, preferably a thermoplastic material, preferably polypropylene.

The bottom dispensing package (1) can further comprise a baffle (60) located in between the interior side (45) of the orifice (30) and the impact resistance system (50), preferably the baffle (60) includes an occlusion member (61) supported by at least one support member (62) which accommodates movement of the occlusion member (61) between a closed position occluding liquid flow when the baffle (60) is subjected to an upstream hydraulic hammer pressure.

The base (20) can comprise a bottom surface (21) which can optionally be adapted for resting the package (1) on a flat surface. Alternatively, the base (20) can comprise a base wall (23), at least partially, preferably fully connected to the periphery of the bottom surface (21), and extending from said periphery of the bottom surface (21) to a base wall rim (22), such that the bottom-dispensing package (1) can rest on the base wall rim (22). Such a base wall (23) can further comprises an exterior base wall surface (24) and an interior base wall surface (25).

At least part of the base (20) is made from an elastomer, in order to reduce leakage due to transient liquid pressure increases from impact. By making at least part of the base (20) from an elastomer, at least part of the aforementioned transient liquid pressure increases (hydraulic hammer pressure), is absorbed. The body of the base (20) is preferably at least partially made from an elastomer. The body of the base refers to the features of the base (20) which are formed together during moulding of the base (20). That is, excluding those elements, such as the optional slit-valve (40), impact resistance system (50), and the like, which are typically formed separately and mechanically connected to the body of the base (20). As a result, leakage due to transient liquid pressure increases from such impacts is reduced or even avoided. Preferably, the base wall (23) comprises an elastomer. For instance, the base wall (23) can be moulded from a hard plastic such as polypropylene and an elastomeric lip, comprising the base-wall rim (22) can be over-moulded onto the base wall (23). More preferably, the base wall (23) is made from an elastomer.

However, when the base wall (23) is at least partially made from elastomer, the base (20) can stick to surfaces due to negative pressure developing within the interior space bounded by the base wall (23), especially when the base wall rim (22) is wet. As such, the base wall (23) can comprise at least one hole (26) and/or the base rim (22) can comprise at least one channel (27). Since such holes (26) and channels (27) connect the exterior base wall surface (24) and the interior base wall surface (25), the development of a negative “suction” pressure within the region interior to the base wall (23) is avoided. The base wall (23) can comprise from 1 to 8 holes (26), preferably from 1 to 4 holes (26). The base rim (22) can comprise from 1 to 8 channels (27), preferably from 1 to 4 channels (27), more preferably 4 channels (27). Channels (27) in the base wall rim (22) are preferred.

The elastomer used in the base (20) can have a Shore A (Type A) hardness of from 0 to 80, preferably 5 to 60, more preferably 10 to 40. The Shore A hardness can be measured using the method described in ISO 868:2003 (last reviewed and confirmed in 2018). The elastomer can have a tensile elongation (break), measured in the flow direction at a stretch rate of 200 mm/min at 23° C. using the method described in ISO 37:2017 (last reviewed and confirmed in 2022), of from 200% to 1000%, preferably from 250% to 750%, more preferably from 300% to 700%. The elongation at break is a characteristic value that describes the maximum percentage elongation that a tensile specimen experiences at the moment of break. It therefore describes the deformability of a material under tensile load. The elastomer can have a compression set, measured at 23° C. over 72 hours using the method described in ISO 815-1:2019, of less than 50%, preferably less than 35%, more preferably less than 20%. The compression set measures the ability of the elastomer to withstand hardening and retain their elastic properties at ambient temperatures after prolonged compression. As such, the compression set provides an indication of the ability of the elastomer to withstand physical or chemical changes which prevent the elastomer from returning to its original dimensions after release of the deforming force, or lose too much of its elasticity.

The body of the base (20) and the resiliently squeezable container (10) can be co-moulded together, especially where they are made from the same elastomer. In such embodiments, the resiliently squeezable container (10) and the base (20) are essentially a single element.

### Liquid Composition:

Since the bottom dispensing container (1) is less prone to leakage, the bottom dispensing container (1) is particularly suited for containing liquid compositions, especially liquid detergent compositions, having a viscosity of from 100 mPa·s to 3,000 mPa·s, preferably from 300 mPa·s to 2,000 mPa·s, most preferably from 500 mPa·s to 1,500 mPa·s, measured at a shear rate of 10 s⁻¹ following the viscosity test method described herein. The composition can be Newtonian or non-Newtonian, preferably Newtonian.

Preferably, the composition has a density between 0.5 g/mL and 2 g/mL, more preferably between 0.8 g/mL and 1.5 g/mL, most preferably between 1 g/mL and 1.2 g/mL.

The detergent composition, especially when formulated as a hand dishwashing composition, can comprises from 5% to 50%, preferably from 8% to 45%, most preferably from 15% to 40%, by weight of the total composition of a surfactant system.

For hand dishwashing applications, the surfactant system preferably comprises an alkyl sulfate anionic surfactant and a co-surfactant. The co-surfactant can be selected from the group consisting of an amphoteric surfactant, a zwitterionic surfactant and mixtures thereof. The surfactant system can comprise the anionic surfactant and co-surfactant in a weight ratio of from 8:1 to 1:1, preferably 4:1 to 2:1, more preferably from 3.5:1 to 2.5:1.

The surfactant system can comprise from 40% to 90%, preferably from 65% to 85%, more preferably from 70% to 80% by weight of the surfactant system of anionic surfactant, preferably alkyl sulfate anionic surfactant, more preferably alkyl sulfate anionic surfactant selected from the group consisting of: alkyl sulfate, alkyl alkoxy sulfate, and mixtures thereof. Preferred alkyl alkoxy sulfates are alkyl ethoxy sulfates. More preferred anionic surfactants are an alkyl ethoxy sulfate or a mixed alkyl sulfate-alkyl ethoxy sulfate anionic surfactant system, with a mol average ethoxylation degree of less than 5, preferably less than 3, more preferably less than 2 and more than 0.5. The mol average ethoxylation degree is calculated as the mole average degree of ethoxylation for the alkyl ethoxy sulfate blend or, if alkyl sulfate is present, for the mixed alkyl sulfate-alkyl ethoxy sulfate anionic surfactant system.

Preferably the alkyl ethoxy sulfate, or mixed alkyl sulfate-alkyl ethoxy sulfate, anionic surfactant has a weight average level of branching of from 5% to 60%, preferably from 10% to 50%, more preferably from 20% to 40%. The weight average branching degree is calculated as the weight average degree of branching for the alkyl ethoxy sulfate blend or, if alkyl sulfate is present, for the mixed alkyl sulfate-alkyl ethoxy sulfate anionic surfactant system.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company.

The surfactant system may comprise further anionic surfactant, including sulfonate such as HLAS, or sulfosuccinate anionic surfactants. However, the composition preferably comprises less than 30%, preferably less than 15%, more preferably less than 10% by weight of the surfactant system of further anionic surfactant. Most preferably, the surfactant system comprises no further anionic surfactant, other than the alkyl sulfate anionic surfactant.

The composition can further comprise a co-surfactant selected from the group consisting of an amphoteric surfactant, a zwitterionic surfactant and mixtures thereof, as part of the surfactant system. The composition preferably comprises from 0.1% to 20%, more preferably from 0.5% to 15% and especially from 2% to 10% by weight of the cleaning composition of the co-surfactant.

The surfactant system of the cleaning composition of the present disclosure preferably comprises from 10% to 40%, preferably from 15% to 35%, more preferably from 20% to 30%, by weight of the surfactant system of a co-surfactant.

The co-surfactant is preferably an amphoteric surfactant, more preferably an amine oxide surfactant. Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Suitable zwitterionic surfactants include betaine surfactants. Such betaine surfactants includes alkyl betaines, alkylamidobetaine, amidazoliniumbetaine, sulfobetaine (INCI Sultaines) as well as the phosphobetaine. The most preferred zwitterionic surfactant is cocoamidopropylbetaine.

The surfactant system can further comprise from 1% to 25%, preferably from 1.25% to 20%, more preferably from 1.5% to 15%, most preferably from 1.5% to 5%, by weight of the surfactant system, of an alkoxylated non-ionic surfactant.

Preferably, the alkoxylated non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

Alternatively, or in addition, the compositions can comprise alkyl polyglucoside (“APG”) surfactant, to improve sudsing beyond that of comparative nonionic surfactants such as alkyl ethoxylated surfactants. If present, the alkyl polyglucoside can be present in the surfactant system at a level of from 0.5% to 20%, preferably from 0.75% to 15%, more preferably from 1% to 10%, most preferably from 1% to 5% by weight of the surfactant composition.

The cleaning composition can have a pH of from 5 to 12, more preferably from 7.5 to 10, as measured at 10% dilution in distilled water at 20° C. The pH of the composition can be adjusted using pH modifying ingredients known in the art.

Suitable cleaning compositions are described in European Application EP3511402.

### Test Methods

### Immersed Volume, Overflow Volume and Elasticity Index

The test is done on containers which are at least 3 days old, in order to avoid the effects of container shrinkage after making. The test is done at a room temperature of 20° C. and a room atmospheric pressure of 1013+/−1 Pa.

Distilled water having a density of 1.000+/−0.002 g/ml, when measured at 20° C. is added to a beaker of volume at least 5 L. If desired, a dye may be added to improve visibility, so long at the target density is achieved.

The container is weighed using a laboratory balance having an accuracy of 0.001 g.

The container is then fully immersed in the beaker, with the opening facing up with the distilled water in the beaker at 20° C., expelling any remaining air in the container by gentle shaking. Holding the container by the stiffest part of the neck, the container is carefully lifted out of the beaker while avoiding squeezing of the container and spilling any of the solution. The filled container is wiped dry and re-weighed on the balance, in order to measure the weight of solution contained in the container when the container was immersed. From the weight of the distilled water, the immersed volume (ml) can be deduced. The container is then topped up to the brim with additional distilled water at 20° C. and the container reweighed, in order to measure the weight of the distilled water contained within the container after topping up to the brim. From this weight of surfactant solution, the overflow volume can be deduced. The overflow volume is the total volume of the distilled water contained in the container after topping up. The time between immersion in the basin and weighing must be less than 2 minutes.

The elasticity index is calculated using the following equation, expressed as a percent:

$$Elasticity index = \frac{Overflow volume - Immersed volume}{Immersed volume} \times 100 \%$$

### Peak Pressure

The peak pressure is the pressure within the empty container at a defined temperature above the fill temperature. A temperature and pressure probe (preferably MSR145B4 data logger) is placed within the empty container and the container is capped with a sealingly engaged cap (without an orifice), with the container maintained at a temperature of 20° C. and an atmospheric pressure of 1013+/−1 Pa, while ensuring that no additional pressure beyond the surrounding atmospheric pressure is exerted on the container during capping. The container is placed within a constant temperature oven, set at the desired temperature for 4 hours at 1013+/−1 Pa and the maximum (peak) pressure logged by the temperature and pressure probe is recorded. The method is repeated using 5 different containers and the average peak pressure is recorded.

### Leakage

The containers are filled to 10% of the container size (recommended fill volume) at 20° C. with Fairy® original dark green dishwashing product having a viscosity in the range of 1,000+/−200 mPa·s, measured at a shear rate of 10 s⁻¹ (for example, Belgian market product, 2018), and the containers sealed with caps comprising V21-145 slit-valves (supplied by Aptar). Cups are weighed before the containers are placed upside down in the cups, with the container cap positioned a distance from the bottom of the cup. The containers are then placed, with the cups in a constant temperature oven kept at 40° C. The containers and cups are then removed from the oven after an hour, the container removed from the cup and the cup reweighed, in order to measure the weight of product that has leaked from the container.

### Leakage Resistance

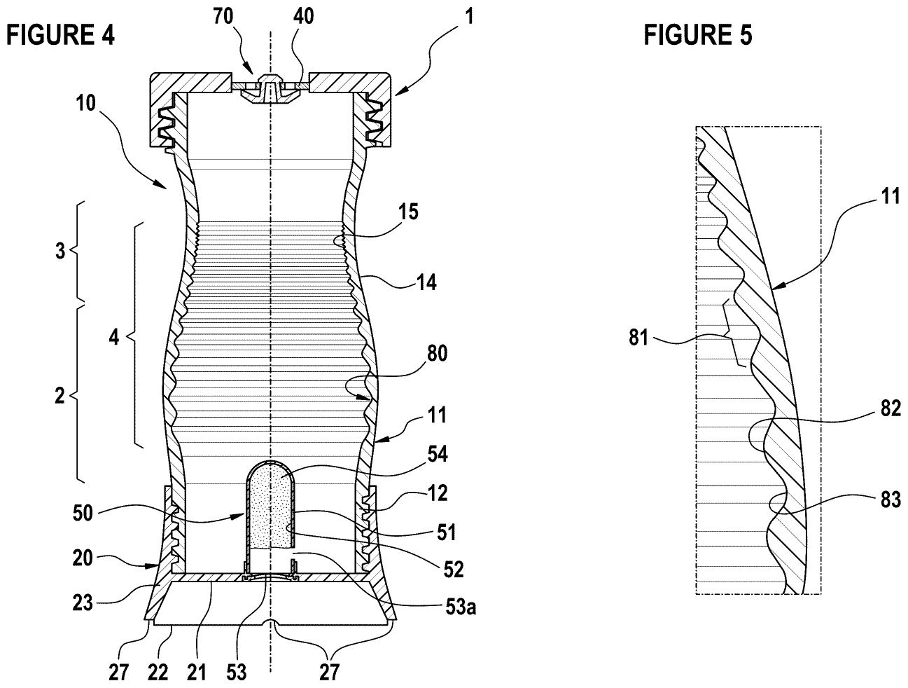

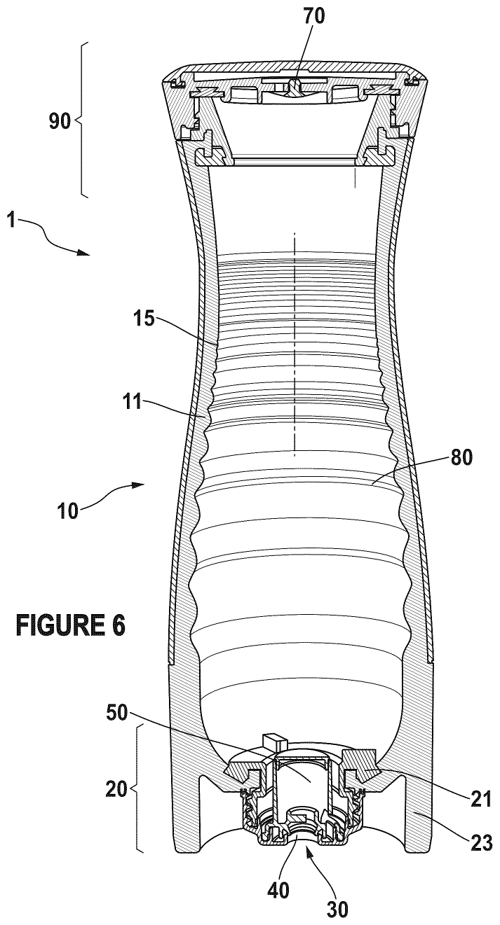

The purpose of the Leakage Resistance Test is to assess the ability of a liquid dispenser to prevent leakage of the liquid from an inverted container during “impact”. The impact occurs when the inverted container is dropped, liquid dispenser side down, from a certain height onto a flat surface. The drop is supposed to mimic the resulting transient liquid pressure increases upon impact inside the inverted container. The leakage resistance ability of the liquid dispenser is evaluated through measurement of the drop height till which no volume/weight of the liquid leaks out when dropped. A higher leak-free drop height correlates to better leakage resistance ability for the liquid dispenser. The steps for the method are as follows:
1. Use a drop tester apparatus as shown in FIG. 10. The apparatus consists of two top and bottom open ended cylindrical tubes with an approximate diameter of 12 cm, i.e. an outer tube tightly surrounding an inner tube movable in vertical direction into the outer tube, the outer tube having a cut out section to enable visual assessment of the relative height of the inner tube within the outer tube through a grading scale applied on the outer tube. A removable lever is applied at the bottom of the inner tube, allowing an inverted container (2) positioned with its opening downwards within the inner tube to rest on the lever. When the lever is manually removed the inverted container drops down and the amount of leaked liquid after the exposure is weighed. Therefore a piece of paper is positioned on a hard surface at the bottom of the open ended outer container to capture the leaked liquid. The weight of the paper is measured on a balance prior and after the drop test to define the amount of leaked liquid. The height at which the lever was positioned prior to manual removal is measured as the drop height.
2. Fill an inverted container (2) having a defined volume (e.g., 400 mL or 650 mL) with a standard liquid dishwashing detergent having a density of 1.03 g/mL and a Newtonian viscosity of 1000 cps at 20° C. when measured on a Brookfield type DV-II with a spindle 31 at rotation speed 12 RPM to a defined fill level within the inverted container. For example, with a 400 mL inverted container fill with 400 mL of liquid dishwashing detergent, and with a 650 mL inverted container fill with 650 mL of liquid dishwashing detergent. The liquid fill level, inverted container volume and liquid composition is kept constant when cross-comparing different closing systems.
3. Assemble a liquid dispenser comprising a valve (Simplicity 21-200 “Simplisqueeze®” valve available from Aptar Group, Inc.) with the inverted container (2), as shown in FIG. 4. The liquid dispenser has a frustoconical shaped exterior portion (e.g., bottom diameter 65 mm, top diameter 34 mm and height 30 mm) for resting on the flat surface, and optionally fitted with an internally developed baffle (e.g., diameter 7 mm, 5 ribs emerging from center ball of 4 mm to the outside), an impact resistance system (30) according to the present disclosure or both.
4. Set up the drop height (from 2 cm to 15 cm) on the drop tester.
5. Cut a piece of paper approximately 7 cm×7 cm for fitting the opening at the lower end of the outer tube.
6. Weigh the piece of paper using a Mettler Toledo PR1203 balance and record its weight.
7. Place the piece of paper under the opening at the lower end of the outer tube.
8. Place the assembled liquid dispenser and inverted container (2), liquid dispenser side down, into the inner tube of the drop tester.
9. Pull back the lever in the drop tester in a quick and smooth motion.
10. Remove the tubes and the assembled liquid dispenser and inverted container from the drop tester.
11. Weigh the piece of paper a second time and record the weight. Calculate the weight difference of the paper, and the delta corresponds to the amount of liquid leaked from the liquid dispenser.
12. Repeat steps 5 to 11 four more times for a total of five replicates for each test condition.
13. Calculate the average maximum drop height at which no liquid leaked.

### Viscosity

The viscosity of the liquid detergent compositions is measured using a DHR-1 rotational rheometer from TA instrument, using a cone-plate geometry of 40 mm diameter, 2.008° angle with truncation gap of 56 m. Unless otherwise mentioned, the viscosity is measured at a shear rate of 10 s⁻¹.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any example disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A bottom dispensing package for a liquid composition comprising:
a. a resiliently squeezable container for housing the liquid composition; and
b. a base operably connected to the container, wherein the base comprises an orifice;
wherein the body of the base is at least partially made from an elastomer, wherein the elastomer used in the base has a Shore A (Type A) hardness of from about 0 to about 80, wherein the shore A hardness is measured using the method described in ISO 868:2003.

2. The bottom dispensing package according to claim 1, wherein the body of the base is made from an elastomer.

3. The bottom dispensing package according to claim 2, wherein the body of the base and the resiliently squeezable container are co-moulded together.

4. The bottom dispensing package according to claim 3, wherein the body of the base and the resiliently squeezable container are made from the same elastomer.

5. The bottom dispensing package according to claim 1, wherein elastomer used to at least partially make the body of the base is selected from the group consisting of: thermoplastic elastomer, silicone rubber, rubber, or a combination thereof.

6. The bottom dispensing package according to claim 1, wherein the base comprises a base wall, at least partially connected to the periphery of the bottom surface, and extending from the periphery of the bottom surface to a base wall rim, such that the bottom-dispensing package can rest on the base wall rim.

7. The bottom dispensing package according to claim 6, wherein the base wall comprises an elastomer.

8. The bottom dispensing package according to claim 7, wherein the base wall is made of an elastomer.

9. The bottom dispensing package according to claim 7, wherein, the base wall comprises an exterior base wall surface and the interior base wall surface, and the base wall comprises at least one hole and/or the base rim comprises at least one channel, such that the holes and/or channels connect the exterior base wall surface and the interior base wall surface of the base wall.

10. The bottom dispensing package according to claim 9, wherein the base wall comprises from 1 to 8 holes.

11. The bottom dispensing package according to claim 9, wherein the base wall rim comprises from 1 to 8 channels.

12. The bottom dispensing package according to claim 1, wherein the elastomer used in the base has:
a. a Shore A (Type A) hardness of from about 5 to about 60 wherein the shore A hardness is measured using the method described in ISO 868:2003
b. a tensile elongation (break), measured in the flow direction at a stretch rate of about 200 mm/min at about 23° C. using the method described in ISO 37:2017, of from about 200% to about 1000%
c. a compression set, measured at about 23° C. over about 72 hours using the method described in ISO 815-1:2019, of less than about 50%.

13. The bottom dispensing package according to claim 11 wherein the elastomer used to make the resiliently squeezable container has:
a. a Shore A (Type A) hardness of about 5 to about 60 wherein the shore A hardness is measured using the method described in ISO 868:2003
b. a tensile elongation (break), measured in the flow direction at a stretch rate of about 200 mm/min at about 23° C. using the method described in ISO 37:2017, of from about 250% to about 750%
c. a compression set, measured at about 23° C. over about 72 hours using the method described in ISO 815-1:2019, of less than about 35%.

14. The bottom dispensing package according to claim 1, wherein the orifice comprises a slit-valve, wherein the slit valve opens at a pressure differential of from about 10 to about 250 mbar measured at about 20° C.

15. The bottom dispensing package according to claim 1, wherein, the base does not comprise a cap.

16. The bottom dispensing package according to claim 1, wherein the resiliently squeezable container is made from an elastomer wherein the elastomer is selected from the group consisting of: thermoplastic elastomer, silicone rubber, rubber, or a combination thereof.

17. The bottom dispensing package according to claim 15, wherein the resiliently squeezable container comprising a container wall, wherein the container wall of the resiliently squeezable container comprises an interior surface and an exterior surface, wherein the interior surface comprises at least one circumferentially oriented groove.

18. The bottom dispensing package according to claim 1, wherein the container comprises a one-way vent, wherein the one-way vent allows the ingress of air into the container while preventing the egress of air from the container, wherein the one-way vent is positioned in the container top and/or in the container wall above a height of 90% of the height of the package.

19. The bottom dispensing package according to claim 1, wherein the bottom dispensing package comprises a liquid detergent composition, the liquid detergent composition having a viscosity of from about 100 mPa·s to about 3,000 mPa·s measured at a shear rate of about 10 s⁻¹.
